(19) United States
(12) Patent Application Publication
(10) Pub. No.: US 2024/0240737 A1
(43) Pub. Date: Jul. 18, 2024

(54) MULTIMEDIA-COMPATIBLE ROTARY UNION

(71) Applicant: DEUBLIN GMBH, Mainz (DE)

(72) Inventor: Eberhard Grimm, Wiesbaden (DE)

(21) Appl. No.: 18/559,285

(22) PCT Filed: Apr. 26, 2022
(86) PCT No.: PCT/EP2022/061118

§ 371 Date: Nov. 6, 2023

(30) Foreign Application Priority Data
May 5, 2021 (DE) 10 2021 111 688.0
May 5, 2021 (DE) 10 2021 111 690.2
Dec. 3, 2021 (DE) 10 2021 131 994.3
Dec. 3, 2021 (DE) 10 2021 131 995.1

(51) Int. Cl. F16L 27/08

(52) U.S. Cl. CPC F16L 27/0828

(57) ABSTRACT

A multimedia-compatible rotary union for transferring fluid media from stationary to a rotating machine parts, includes a stationary housing part having a media main channel, a rotor fluidically connected to the media main channel, a mechanical seal between the stationary housing part and the rotor and having a rotor seal ring that rotates with the rotor, and a stator seal ring, wherein the stator seal ring or the rotor seal ring is fastened to a seal ring carrier, forming a seal ring assembly, wherein pressure of a medium exerts a first axial force component on the seal ring assembly and closes the mechanical seal, and a tensioning device which is activated by the medium pressure when the medium pressure exceeds a predefined pressure threshold value and exerts a second axial force component on the seal ring assembly to influence the closing force of the mechanical seal.

### CROSS REFERENCES

This application is a U.S. National Phase Application of International Application No. PCT/EP2022/061118 filed on 26 Apr. 2022, which claims priority to German Application Nos. DE 10 2021 111 688.0 and DE 10 2021 111 690.2, each filed on 5 May 2021, and DE 10 2021 131 994.3 and DE 10 2021 131 995.1, each filed on 3 Dec. 2021, the disclosures of each of which are hereby incorporated by reference herein in their entireties.

### TECHNICAL FIELD

The present disclosure relates in general to a multimedia-compatible rotary union or rotary feedthrough for transferring different fluid media, having different viscosities, from a stationary machine part to a rotating machine part, and in particular to a multimedia-compatible rotary union in which different media, in particular having very different viscosities, e.g. compressible media on the one hand and higher-viscosity incompressible media on the other hand, can be introduced selectively, in a pressurized manner, into the rotary union.

### BACKGROUND

Rotary unions are typically used for feeding fluid media into a rotating machine part, e.g. a rotating spindle of a machine tool. For this purpose, the rotary union contains a seal between stationary components and rotating components. This seal can be designed as an axial mechanical seal. Typically, in the case of an axial mechanical seal, two slide rings or sliding seal rings slide on one another, wherein one of the seal rings rotates relative to the other, coaxially to the axis of rotation, and the seal rings seal against one another, by their opposing, mutually adjoining, annular end faces, in order to seal the interior, pressurized with a fluid medium, against the atmospheric pressure in the outside region. The type of the fluid media to be transferred by means of the rotary union can vary and in particular include compressible media, such as gases, e.g. compressed air, and liquid media, such as cooling lubricants (CL), and oils, such as cutting oil or hydraulic oil. Cooling lubricant (CL) usually consists substantially of an oil-in-water emulsion and typically has a viscosity which is not very much greater than the viscosity of pure water, i.e. a relatively low viscosity. In contrast, cutting oil and hydraulic oil have a significantly higher viscosity, which can be up to 60 mm²/s (cost) or more. A likewise known method is what is known as reduced or minimum quantity lubrication (RQL/MQL). This typically uses an aerosol in the form of an oil-gas mixture, i.e. substantially also a compressible medium.

There is a plurality of rotary unions in existence which are usually more or less optimized for one or a few particular ones of the above-mentioned fluid media, and/or for particular ranges of allowable operating parameters. Although rotary unions are also known which can be operated using different fluid media having different properties or viscosities, it has been found that these are sometimes not universal or reliable to the desired extent. For example, under certain conditions and/or in the case of some media under some circumstances, for example at high rotational speeds, these can overheat, which can lead even to destruction of the rotary union. Inter alia it has been found that some allegedly universal rotary unions may exhibit significant problems with respect to stability, for example in dry running or with compressed air, at high rotational speeds. Dry running typically refers to the rotating operation of a rotary union without pressurization with a medium.

Furthermore, conventional rotary unions may sometimes have a relatively high leakage rate in compressed-air operation, e.g. of up to 100 standard liters per minute, or more, which may also be undesirable.

In the patents EP 1 744 502 B1 and EP 2 497 978 B1 by the Deublin Company, a technology is described in which the balance ratio of the mechanical seal is in a specially preselected interval, and a suitable contact pressure between the two seal rings is ensured in a wide pressure and rotational speed range. The technology by Deublin is also known among experts under the designation AutoSense®.

Overall, a plurality of the commercially available conventional rotary unions is limited to a greater or lesser extent, in various ways, in view of all the sometimes contradictory requirements placed on rotary unions, such as area of use of the operating parameters, variety with respect to the useable fluid media, stability, simplicity for the user, universality, etc.

From the applications DE 10 2021 111 688 and DE 10 2021 111 670 of the same applicant, both filed on 5 May 2021 and not previously published, which are hereby incorporated by reference, multimedia-compatible rotary unions are known which have two different balance ratios for media of different viscosities, wherein the balance ratios are controlled via different media inlet channels. For some applications, the plurality of media connections required for this may be less desirable.

### SUMMARY

The object of the present disclosure is that of providing a multimedia-compatible rotary union which is suitable for different media, in particular compressible media, e.g. compressed air, on the one hand, and incompressible media of high viscosity, e.g. cutting oil or hydraulic oil, on the other hand.

A further aspect of the object is that of providing a multimedia-compatible rotary union which has a low leakage rate during operation with different media, viscosities and pressures, and operates in a durable and low-wear manner, even at high rotational speeds.

A further aspect of the object is that of providing a multimedia-compatible rotary union which operates i) with cutting or hydraulic oil, ii) with cooling lubricant (CL), iii) with compressed air, iv) with aerosol media for reduced or minimum quantity lubrication, and also v) without media and without pressure, i.e. in dry running, in each case at high rotational speeds in a durable and low-wear manner.

A further aspect of the object is that of providing a multimedia-compatible rotary union which combines a high degree of universality (“one-for-all”) and simplicity of use for the user, and allows backward compatibility for users of conventional rotary unions.

A further aspect of the object is that of providing a rotary union which does not have the disadvantages described above, or has them only to a small degree.

According to one aspect of the present disclosure, a multimedia-compatible rotary union for transferring different fluid media, including both compressible and incompressible media, and media having different, in particular high, viscosities in the same rotary union, from a stationary machine part to a rotating machine part, is provided. The rotary union comprises a stationary housing part for installation in the stationary machine part, and a rotor for connection to the rotating machine part. The stationary housing part encloses an in particular (co)axial media main channel with a central working space in the form of an axial or central inner stator fluid channel. The rotor, for example in the form of a hollow shaft, comprises an also in particular axial or central rotor fluid channel, wherein the fluid channels of the stationary housing part and of the rotor are permanently, i.e. also during rotation, fluidically connected to one another, in such a way that the rotor can rotate relative to the stationary housing part, optionally with a high rotational speed, and the respective pressurized medium flows, during the rotation, from the media main channel of the stationary housing part into the rotor fluid channel of the rotating rotor, in order to be conducted out of the rotor fluid channel into the connected rotating machine part. The stationary housing part can be formed in one piece or in multiple parts.

The rotary union comprises an axial mechanical seal or end-face mechanical seal between the stationary housing part and the rotor, which seals the fluidic connection between the rotor and the stationary housing part during the rotation. For this purpose, the mechanical seal comprises a slide ring or sliding seal ring that rotates together with the rotor, known as the rotor seal ring, and a non-rotating slide ring or sliding seal ring, known as the stator seal ring, wherein the two seal rings seal the transition between the stationary and the rotating region of the rotary union, by means of their opposing annular sealing surfaces that rotate relative to one another. In order that the mechanical seal can open in a controlled manner, e.g. in dry running without pressure or in compressed-air operation, at least one of the two seal rings is suspended so as to be slightly axially movable. For this purpose, said seal ring is fastened to an axially movably mounted seal ring carrier, such that the seal ring carrier and the associated seal ring form an axially movable seal ring assembly, and the mechanical seal can open and close by axial movement of the seal ring assembly, i.e. of the seal ring carrier with the seal ring fastened thereon. From a structural perspective, it is usually easier to suspend the stator seal ring in an axially movable manner. In this case, the axially movable seal ring carrier, together with the stator seal ring fastened thereon, forms an axially movable stator seal ring assembly. The stator seal ring assembly is mounted so as to be axially displaceable in the inner fluid channel of the stationary housing part, by means of the seal ring carrier, and can preferably compensate some angular play, in order to ensure precise sealing between the adjoining sealing surfaces of the two seal rings. A (stator) seal ring which is axially displaceable in this way and is optionally slightly tiltable is also referred to by experts as a floating (stator) seal ring.

In other words, in the case of a floating stator seal ring the mechanical seal comprises a seal ring assembly, which is axially movable, but non-rotating, in the stationary housing part, comprising the stator seal ring and a complementary rotor seal ring that rotates together with the rotor. The rotor seal ring can be fastened, e.g. pressed and/or adhesively bonded or otherwise fastened, for example at the end face of the rotor facing the stationary housing part.

However, it is not impossible to reverse the assembly consisting of the floating seal ring and the seal ring complementary thereto, i.e. to suspend the rotor seal ring in an axially movable manner, in order to form the rotor seal ring as a floating seal ring. In both cases, the mechanical seal can be formed having Pop-Off® functionality. The seal ring assembly consisting of the seal ring carrier and seal ring can optionally be formed in one piece.

When medium pressure is applied to the media main channel, the medium flows through the mechanical seal into the fluid channel of the rotor. At the same time, the medium pressure is applied to the axially movable seal ring assembly, which pressure exerts a first axial force component on the axially movable seal ring assembly, which acts on the mechanical seal in a closing manner. This first axial force component which acts in a closing manner depends on the balance ratio, i.e. on the geometric area ratios of the mechanical seal, and increases proportionally with the applied medium pressure.

In order to furthermore be able to additionally influence the axial closing force on the mechanical seal, the rotary union according to the present disclosure also comprises an axially movable tensioning device within the stationary housing part, which tensioning device acts on the axially movable seal ring assembly and which defines a non-activated and an activated state. The tensioning device is activated by the medium pressure prevailing in the media main channel when the medium pressure in the media main channel exceeds a predefined pressure threshold value as a pressure switching value. The tensioning device is thus hydraulically activated, i.e. hydraulically enabled. When the medium pressure falls below the pressure threshold value again, the tensioning device is deactivated, i.e. hydraulically disabled.

In other words, the tensioning device switches, in response to the medium pressure in the rotary union exceeding a predefined pressure threshold value, from the non-activated state into the activated state. In response to the medium pressure in the rotary union falling below a predefined pressure threshold value, the tensioning device switches from the activated state back into the non-activated state.

In the activated state, the tensioning device generate an additional second axial force component, which acts on the axially movable seal ring assembly in addition to the first axial force component, which is proportional to the medium pressure, and thus contributes to the closing force of the mechanical seal, in particular amplifies the closing force of the mechanical seal between the stator seal ring and the rotor seal ring. In other words, in the non-activated state of the tensioning device the second axial force component does not act, such that the closing force of the mechanical seal is brought about merely by the first axial force component and, in the activated state of the tensioning device, the first and the second axial force component add up to a total closing force, which is in particular greater than the first axial force component which is defined by the balance ratio.

When the tensioning device is not activated, the mechanical seal preferably operates as a balanced mechanical seal, in which the balance ratio is selected in such a way that the mechanical seal is balanced at least largely, optionally exclusively, hydraulically or pneumatically. Corresponding rotary unions having a balance ratio in a specific range are provided, by the applicant, with the designation Autosense®. A particular feature of the present rotary union is that the mechanical seal operates as a balanced mechanical seal, below the pressure threshold value, i.e. as long as the tensioning device is not activated, and exceeding of the pressure threshold value causes the tensioning device to be activated or hydraulically enabled, which brings about an amplification of the closing force.

Preferably, the tensioning device is mounted in the stationary housing part so as to be axially movable relative to the seal ring assembly, in order to apply the additional second axial force component to the seal ring assembly, e.g. in that the tensioning device presses axially against the seal ring assembly.

The mechanical seal comprising the floating seal ring defines a balance ratio B=F_{H}/F, wherein F_{H} is the surface area of the seal ring assembly that is hydraulically or pneumatically loaded by the medium pressure, and F is the contact surface between the stator seal ring and the rotor seal ring. The first axial force component on the seal ring assembly is based on the balance ratio of the mechanical seal, and specifically irrespective of whether the tensioning device is activated or not activated, i.e. in the same way in the case of an activated or non-activated tensioning device, and increases proportionally with the medium pressure in the rotary union. The second axial force component, generated by the tensioning device, on the seal ring assembly is now added, in addition to the first axial force component based on the balance ratio, such that a total closing force acts on the mechanical seal, which is formed as the sum of the first and second axial force component, if and only if the medium pressure exceeds the pressure threshold value and the tensioning device has been activated. In particular, the additional second axial force component thus does not act if and as long as the medium pressure remains below the pressure threshold value.

In other words, when the pressure threshold value is exceeded, the tensioning device adds in an additional second axial force component, such as a booster, which amplifies the closing force over-proportionately to the first axial force component. The tensioning device accordingly forms a closing force amplification device, which is activated when the pressure threshold value is exceeded. In this case, the activation of the closing force amplification device takes place in particular hydraulically, by the medium pressure.

As a result, for example in the case of compressed-air operation below the pressure threshold value, i.e. at a relatively low pressure, e.g. less than or equal to 10 bar, the mechanical seal can be operated in a balanced manner with the balance ratio B, wherein the balance ratio B allows for a controlled (slight) opening of the mechanical seal with controlled desired air leakage, and is therefore suitable for compressed-air operation with rotation. In the case of pressurization of the media main channel with a higher-viscosity incompressible medium, e.g. cutting oil or hydraulic oil at a higher pressure, in particular greater than 10 bar, the tensioning device is activated, as a result of which an amplification of the closing force is brought about, which is suitable for higher-viscosity cutting oil or hydraulic oil and prevents excessive leakage.

Cutting oil can for example have a viscosity in the range from 6 mm²/s to 18 mm²/s, and hydraulic oil can have a viscosity in the range from 32 mm²/s to 46 mm²/s (40° C.), optionally even up to 60 mm²/s (40° C.). The rotary union can be operated with the activated tensioning device, but also with a lower-viscosity liquid medium, e.g. cooling lubricant (CL), e.g. having a viscosity in the range from 1 mm²/s to 3 mm²/s.

As a result, the rotary union can be operated both with the compressible media and with the incompressible media, at high rotational speeds in each case, e.g. up to more than or equal to 24,000 min⁻¹, without excessive heating of the seal rings. Nonetheless, the rotary union can on the one hand have an acceptably low air leakage rate in compressed-air operation, and on the other hand operate in substantially leak-free manner with an incompressible or liquid medium, even of higher viscosity.

Advantageously, in compressed-air operation a small gap results between the two sealing surfaces of the seal rings (controlled opening of the mechanical seal), such that no wear occurs and a desired controlled slight air leakage escapes. In contrast, in the case of liquid media having high viscosity, such as cutting oil or hydraulic oil, the two seal rings are pressed against one another with the amplified closing force, i.e. the mechanical seal is closed, such that a gap enlargement is prevented.

Accordingly, he rotary union preferably defines at least two operating states, as follows:
In the case of pressurization with a medium pressure below the pressure threshold value, the rotary union defines a compressed-gas operating state for the operation with a compressible medium. In the compressed-gas operating state, the mechanical seal is open minimally, in order to allow a controlled leakage. In the compressed-gas operating state for compressible media, the tensioning device is not activated. Thus, only the first axial force component acts, based on the balance ratio.
In the case of pressurization with a medium pressure above the pressure threshold value, the rotary union defines a liquid-medium operating state for compressible media under a high medium pressure. In the liquid-medium operating state, the mechanical seal is closed, and the tensioning device is activated. Accordingly, in the liquid-medium operating state the first axial force component, based on the balance ratio B, and in addition the second axial force component, brought about by the activated tensioning device act, added together as the total closing force, on the mechanical seal. As a result, a sufficient tightness can be achieved for operation using higher-viscosity media such as cutting oil or hydraulic oil, in the case of a high medium pressure.

The switching between the compressed-gas operating state and the liquid-medium operating state takes place hydraulically, by the medium pressure prevailing in the rotary union.

Thus, in an advantageous manner, a universal multimedia-compatible rotary union can be provided, which is suitable for pressurization with very different media, specifically compressible media on the one hand, e.g. compressed air, and highly viscous liquid media on the other hand, e.g. cutting oil or hydraulic oil, and specifically has high stability at high rotational speeds, and a leakage rate in the case of all the media used, in particular is substantially leak-free in the case of liquid media.

If there is no medium pressure prevailing in the media main channel, there is no closing force on the mechanical seal. Optionally, in the state without pressure a secondary seal can pull back the floating seal ring (known as PopOff® function). As a result, in dry running there is no contact between the seal ring sealing surfaces, and temporally unlimited dry running can also take place at high rotational speeds.

Accordingly, the rotary union can define a third operating state, specifically the dry-running operating state. The dry-running operating state is present when the rotary union is in the state without pressure, wherein the mechanical seal is located in a fully open state. In the fully open dry-running operating state the two seal rings are separated from one another by a sufficiently large gap, such that the rotary union can rotate without medium, during dry running, without wear resulting at the seal rings.

The additional second axial force component, which the tensioning device exerts on the seal ring assembly when the medium pressure has exceeded the predefined pressure threshold value, can even be independent of pressure or, in the pressure range above the pressure threshold value, pressure-dependent on the medium pressure, e.g. proportional to the medium pressure. Thus, in the pressure range from 0 bar to the pressure threshold value, the second axial force component can be constantly zero, and can increase e.g. discontinuously at the pressure threshold value, and/or can increase proportionally above the pressure threshold value.

The tensioning device can comprise one or more springs, which are tensioned against the stationary housing part by the prevailing medium pressure in the media main channel.

For example, when a predefined threshold value of the spring tension is exceeded, the tensioning device can be activated, and then and only then exert the additional second axial force component on the seal ring assembly, i.e. when the threshold value of the spring tension is exceeded.

According to one embodiment by way of example, the seal ring carrier comprises an outer (annular) flange, on which the tensioning device engages, in order to transfer the additional second axial force component of the tensioning device to the seal ring assembly.

Furthermore, the tensioning device can comprise a force-distributor ring which distributes the additional second axial force component, exerted by the tensioning device, uniformly to the seal ring carrier in an annular manner, e.g. on the flange.

The tensioning device preferably comprises one or more spring-loaded pistons in the stationary housing part, which pistons are actuated by the medium pressure in the rotary union and, in the actuated state, exert the second axial force component on the seal ring assembly. In other words, the at least one piston is tensioned against the spring force by the medium pressure and exerts the additional second axial force component of the tensioning device onto the seal ring assembly if and only if the medium pressure in the rotary union exceeds the pressure threshold value.

For this purpose, preferably one or more axial bores are provided in the stationary housing part, in which bores the spring-loaded piston(s) are in each case mounted so as to be axially displaceable and are tensioned against the respective spring by the prevailing medium pressure.

Preferably, the spring-loaded piston(s) is/are sealed in the respective associated axial bore by means of a sealing ring, in such a way that the pressurized medium essentially cannot escape via the spring-loaded piston(s).

According to one embodiment by way of example, the medium pressure from the media main channel engages on a rear end face (remote from the rotor) of the piston(s), in order to push the piston(s), in a pressurized manner, in the respective axial bore in the stationary housing part, counter to the spring load, in the direction of the mechanical seal.

Preferably, the tensioning device comprises at least two or three, preferably two to six, preferably two, three or four, spring-loaded pistons, which are arranged in the stationary housing part, in particular uniformly around the seal ring carrier. For example, a systematic action of force on the seal ring assembly can be made possible, and tilting of the seal ring assembly can be prevented, even with two radially opposing spring-loaded pistons. Furthermore, this has proven advantageous with respect to backward compatibility and, inter alia, for reasons of space within the rotary union.

According to one embodiment, the spring-loaded piston(s) rest axially on the outer flange of the seal ring carrier or axially on the force-distributor ring, when the pressure threshold value is exceeded, in order to transmit the additional second axial force component of the tensioning device directly onto the outer flange or directly onto the force-distributor ring, which may be economical with respect to the spatial conditions within the stationary housing part.

For example, the stationary housing part comprises a stop for the spring-loaded piston(s), which limits the axial stroke of the spring-loaded piston(s) in that the spring-loaded piston(s) strike the respectively associated stop when the pressure threshold value is exceeded, and the tensioning device is activated. Furthermore, the spring-loaded piston(s) can each comprise a closing force activation spring which, in the activated state of the tensioning device, exert a constant media pressure-independent spring force on the seal ring assembly, such that the additional second axial force component generated by the tensioning device on the seal ring assembly is constant, in a manner independent of the media pressure, when and as long as the tensioning device is activated.

The pressure threshold value is preferably greater than the maximum permissible operating pressure of the rotary union compressed-air operation. It is thus possible to ensure that the tensioning device is not activated in the entire allowable pressure range for compressed-air operation, and the rotary union rotates, in compressed-air operation, with the balance ratio and without the additional second force component, such that an air gap can form and controlled air leakage can take place (AutoSense®). For this purpose, the pressure threshold value can be for example greater than 5 bar, preferably greater than or equal to 10 bar, preferably between 5 bar and 100 bar, preferably between 10 and 50 bar, preferably between 10 and 30 bar. In other words, the pressure threshold value is preferably selected to be at least so high that the closing force amplification device is not activated, i.e. remains switched off, in compressed-air operation.

The rotary union further comprises a connection port for connection of a media pressure line, in order to introduce the desired media, with a medium-specific desired medium pressure, into the media main channel. Preferably, the rotary union is a single port rotary union, i.e. has just one single connection port for connection of a media pressure line, and one single media main channel through which all the desired different media are conducted (alternately). The rotary union is thus arranged such that both compressible media, in particular compressed air, and incompressible media, in particular cutting oil or hydraulic oil, can be introduced into the same media main channel, in a pressurized manner, via the same connection port. In this case, all the media are introduced alternately (not simultaneously) via the same connection port, and a pressure increase of the currently present medium above the pressure threshold value in the single media main channel causes the hydraulic activation of the tensioning device, and/or the pressure drop of the currently present medium in the single media main channel below a pressure threshold value causes the deactivation of the tensioning device.

Advantageously, the rotary union can thus make do with one single connection port for connection of a media pressure line, in order to introduce all desired media into the media main channel, in each case having an associated medium-specific desired medium pressure, and the rotary union is nonetheless suitable for both compressible media, in particular compressed air, and incompressible media, in particular cutting oil or hydraulic oil, to be able to be introduced into the same media main channel, in a pressurized manner, via the same connection port, wherein the closing force of the mechanical seal is advantageously in a suitable range in the case of all medium pressures, i.e. controlled air leakage in compressed-air operation or RQL/MQL with relatively low medium pressure, and reliable closing of the mechanical seal during operation with cutting oil, hydraulic oil or CL at relatively high medium pressure.

The connection port is preferably a (co)axial connection port. However, with regard to specific customer requirements, the possibility should not be excluded, in principle, of using a radial connection port and/or a plurality of connection ports, although these are not required for the multimedia compatibility of the rotary union.

Preferably, the media main channel extends in particular (co)axially from the connection port to the mechanical seal. Preferably, the media main channel from the connection port to the mechanical seal is permanently open, i.e. the coaxial media main channel itself preferably does not contain any valves which would disturb the flow of the media from the connection port through the media main channel into the rotor fluid channel. As a result, inter alia an undesired demixing in the media main channel can be prevented, e.g. when the rotary union is operated with minimum quantity lubrication (RQL/MQL).

The currently desired medium and the respective medium pressure are set by the user, at a media distribution network outside of the rotary union. For this purpose, outside of the rotary union, at least two media sources, two media supply lines, a distributor, and external valves in the media supply lines for the different media, in particular having different viscosities, in particular both at least one compressible medium and at least one incompressible medium, such as compressed air, and at least one incompressible liquid medium, such as cutting oil, hydraulic oil or CL, are included. The medium supply lines, in particular for compressed air on the one hand and for cutting oil, hydraulic oil or CL on the other hand, are interconnected outside of the rotary union via the distributor, in order to select the medium desired in each case from outside the rotary union, by means of the external valves, and in order to introduce said medium into the preferably single media main channel, via the single connection port, with the desired medium pressure. That is to say that all the permitted media are switched on and switched off alternately, outside of the rotary union, and preferably introduced into the rotary union alternately, i.e. in temporal succession, via the same connection port.

Preferably, the balance ratio of the mechanical seal is in the range from approximately 0.40 to 0.65, preferably in the range from approximately 0.45 to 0.60, preferably in the range from approximately 0.47 to 0.60, preferably in the range from approximately 0.50 to approximately 0.57. This allows, in compressed-air operation, for controlled opening of the mechanical seal and thus controlled air leakage which is not excessively great.

The seal ring carrier is preferably axially displaceably mounted and sealed in the stationary housing part by means of an elastomer secondary seal. The secondary seal can for example comprise an elastomer ring, which is arranged on the outside diameter of the seal ring carrier and has a U-shaped cross section for example. In the case of pressurized closure of the mechanical seal, the secondary seal can be tensioned axially and, upon depressurization, can pull the seal ring carrier, together with the stator seal ring, away from the rotor seal ring, in order to open the mechanical seal sufficiently wide for dry running (known as PopOff® function). The opening of the mechanical seal during dry running can thus be assisted for example by shape restoration of the elastomer ring. This can contribute to virtually unlimited wear-free dry running at high rotational speeds.

Preferably, at least one of the two seal rings, in particular both seal rings, of the mechanical seal is/are formed as a silicon carbide seal ring (SiC).

The rotary union is for example connected and operated as follows:

The user connects an external compressed gas source, via an external compressed gas supply line and an external distributor or external manifold, e.g. a multi-way valve, to the connection port of the rotary union, and an external media reservoir comprising an incompressible liquid medium, such as oil, in particular cutting oil or hydraulic oil having a viscosity of greater than or equal to 6 mm²/s, or CL, is connected via an external liquid medium pressure supply line, and the external distributor is connected to the same connection port of the rotary union.

During operation, in a first time interval compressed gas, e.g. compressed air, of a lower pressure than the oil or the cooling lubricant, in particular of a pressure of less than or equal to 10 bar, is then introduced via the compressed gas supply line and the connection port into the media main channel, wherein the tensioning device is not activated and the rotary union rotates with the compressed gas and with a closing force on the mechanical seal, which is defined by the balance ratio of the mechanical seal, and wherein later the compressed gas is switched off again.

In a second following time interval, the incompressible liquid medium, in particular cutting oil or hydraulic oil having a viscosity of more than or equal to 6 mm²/s or cooling lubricant, at a higher pressure than the compressed gas, in particular at a pressure of greater than 10 bar, is introduced via the liquid medium pressure supply line, the external distributor and the same connection port into the media main channel, wherein the tensioning device is activated, i.e. hydraulically enabled, by the present higher pressure of the liquid medium, and the rotary union rotates with the liquid medium and with an added closing force on the mechanical seal, wherein the added closing force is made up of the first axial force component and the additional second axial force component, wherein the first axial force component is generated by the balance ratio from the liquid pressure and the additional second axial force component is generated by the activated tensioning device. Later, the incompressible liquid medium is switched off again, as a result of which the tensioning device is deactivated again.

Thus, the rotary union can be operated, via the same connection port and the same media main channel, successively with different media, including both compressible and incompressible media, of the respectively suitable pressures, and the tensioning device is activated in response to the increase of the medium pressure above the pressure threshold value, in order to amplify the closing force.

Subsequently, in a third time interval the rotary union can rotate without medium, during dry running, wherein the tensioning device is not activated, and the mechanical seal is held open in particular by the secondary seal, e.g. by the U-cup ring.

The rear end of the seal ring carrier, remote from the mechanical seal, preferably opens into the working space or media main channel, which in particular extends coaxially with the rotor, the mechanical seal and/or the seal ring carrier. The rotor preferably comprises just one single central rotor fluid channel. Further preferably, the rotary union comprises just one single axial mechanical seal.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a longitudinal section through a rotary union according to one embodiment of the present disclosure, having an open mechanical seal,

FIG. 2 as FIG. 1, but having the mechanical seal in the state for compressed-air operation and a non-activated tensioning device,

FIG. 3 as FIG. 1, but having a closed mechanical seal for operation with incompressible media, and an activated tensioning device,

FIG. 4 is a detailed enlargement of the seal ring assembly and the tensioning device from FIG. 1,

FIG. 5 is a detailed enlargement of the seal ring assembly and the tensioning device from FIG. 2,

FIG. 6 is a detailed enlargement of the seal ring assembly and the tensioning device from FIG. 3,

FIG. 7 is a longitudinal section through a rotary union according to a further embodiment of the present disclosure, having an open mechanical seal,

FIG. 8 as FIG. 7, but having the mechanical seal in the state for compressed-air operation and a non-activated tensioning device,

FIG. 9 as FIG. 7, but having a closed mechanical seal for operation with incompressible media, and an activated tensioning device,

FIG. 10 is a detailed enlargement of the seal ring assembly and the tensioning device from FIG. 7,

FIG. 11 is a detailed enlargement of the seal ring assembly and the tensioning device from FIG. 8,

FIG. 12 is a detailed enlargement of the seal ring assembly and the tensioning device from FIG. 9,

FIG. 13 is a longitudinal section through a rotary union according to a further embodiment of the present disclosure, having an open mechanical seal,

FIG. 14 as FIG. 13, but having the mechanical seal in the state for compressed-air operation and a non-activated tensioning device,

FIG. 15 as FIG. 13, but having a closed mechanical seal for operation with incompressible media, and an activated tensioning device,

FIG. 16 is a detailed enlargement of the seal ring assembly and the tensioning device from FIG. 13,

FIG. 17 is a detailed enlargement of the seal ring assembly and the tensioning device from FIG. 14,

FIG. 18 is a detailed enlargement of the seal ring assembly and the tensioning device from FIG. 15,

FIG. 19 is a schematic view of the diameter ratios of a seal ring assembly comprising a floating seal ring, for calculating the balance ratio B,

FIG. 20 is a schematic view of an external media distribution network.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

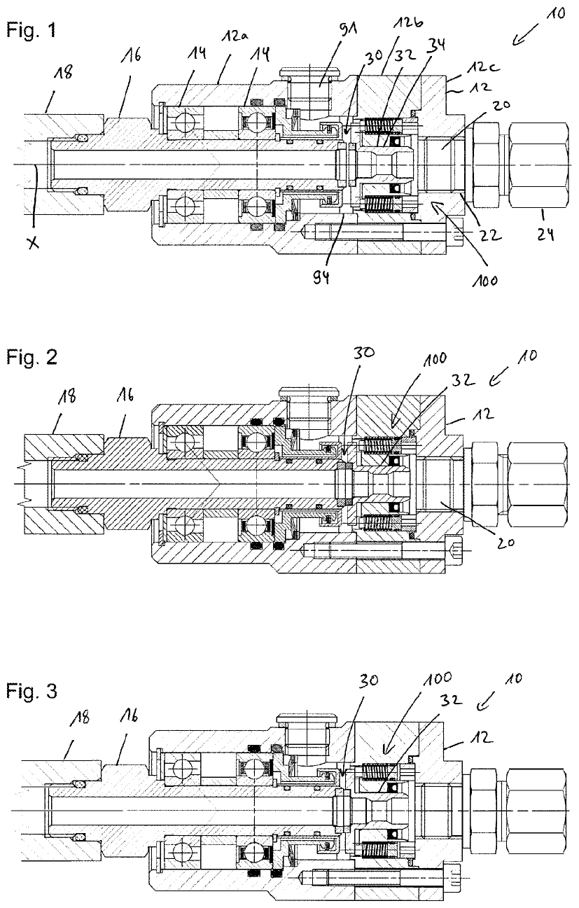

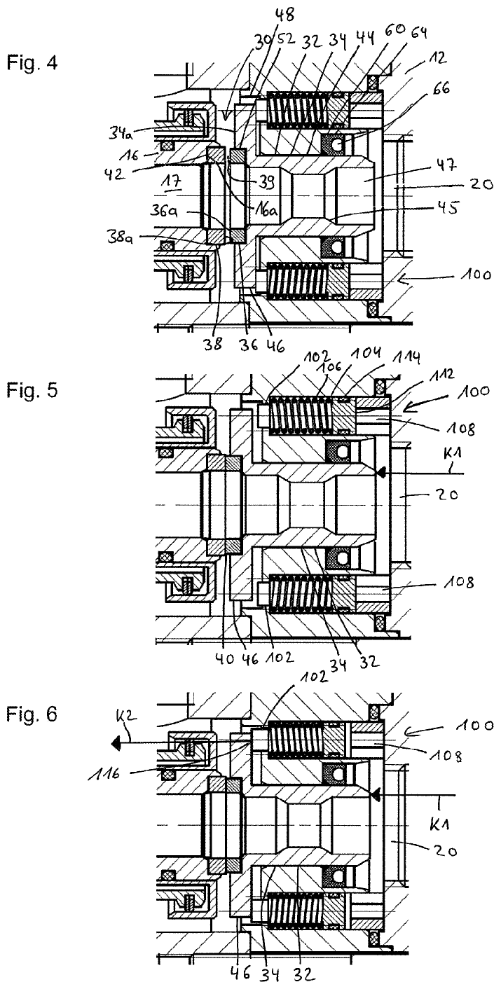

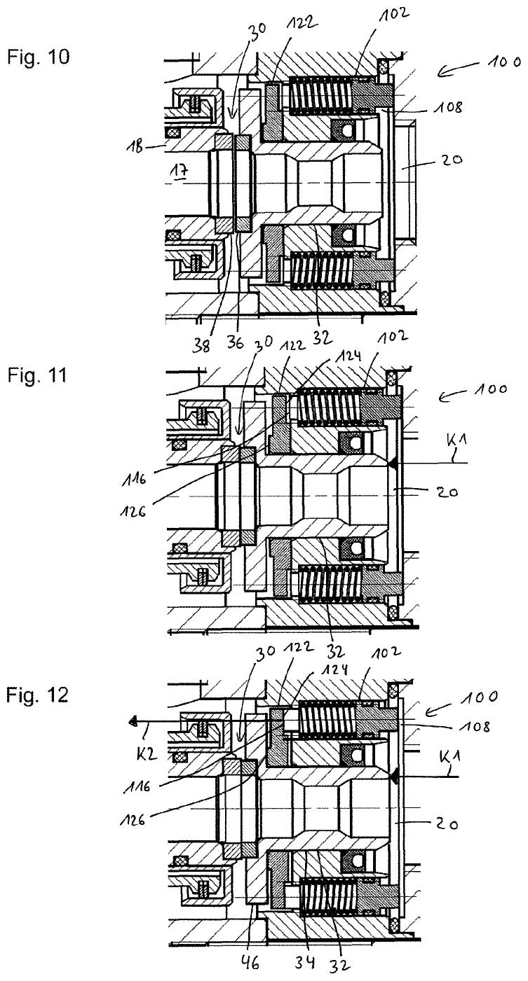

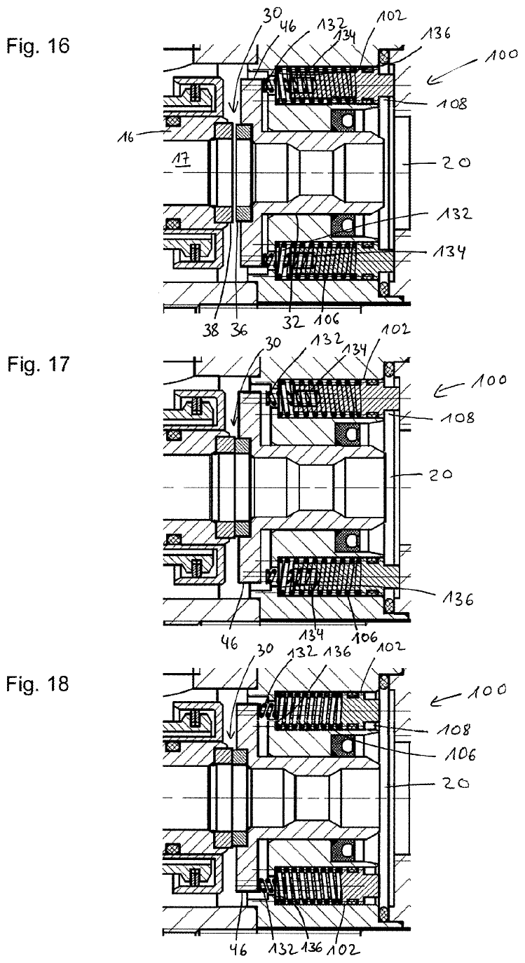

With reference to FIG. 1 to 18, the rotary union 10 comprises a stationary housing part 12 at the rear, which is formed in multiple parts in the present example. A rotor 16, in these examples in the form of a hollow shaft, for connection to a machine spindle 18 is mounted in the stationary housing part 12 in a rotating manner by means of primary rolling bearings, e.g. ball bearings 14. The rotary union 10 in particular comprises one single media main channel 20 in the stationary housing part 12, and one single connection port 22, e.g. having one single screw-in fitting 24 for connection to suitable tube or pipe systems, in order to introduce the desired fluid media into the stationary housing part 12 of the rotary union 10, under pressurization, via the same connection port 22, into the same media main channel 20 extending coaxially with the axis of rotation X of the rotary union 10. In this case, the media main channel 20 is pressurized alternately and not simultaneously with the currently desired medium, in each case, from a group of the suitable media. In this case, the group of suitable media comprises both compressible and incompressible media. The group of suitable media can in particular comprise on the one hand compressed air, reduced quantity lubrication or minimum quantity lubrication (RQL/MQL) as compressible media, and, on the other hand, cooling lubricant (CL), cutting oil and/or hydraulic oil as incompressible media. In this case, the rotary union is in particular operable at least by means of compressed air on the one hand and by means of an oil, e.g. cutting oil or hydraulic oil, on the other hand.

The stationary housing part 12 and the rotor 16 are sealed by means of an axial mechanical seal 30. The mechanical seal 30 comprises a seal ring assembly 32 comprising an axially displaceable seal ring carrier 34 and a seal ring 36 fastened to the seal ring carrier 34. The seal ring 36 of the stator, or stator seal ring 36 for short, seals, with its rotor-side axial annular sealing surface 36a, against a rear axial annular sealing surface 38a of the complementary seal ring 38 of the rotor 16. The seal ring 38 of the rotor 16, or rotor seal ring 38 for short, is fastened on the stator-side end face 16a of the rotor 16, in these examples pressed and/or adhesively bonded into an annular groove 42, wherein other fastening techniques are also possible, however.

The seal ring carrier 34 of the stator seal ring 36 is designed for example as a hollow piston 44 and mounted in the stationary housing part 12 in particular in a torsion-proof, but axially movable, manner. The seal ring carrier 34 comprises a rotor-side flange 46 which is accommodated in a torsion-proof manner in a corresponding rotor-side recess 48 in the stationary housing part 12. The torsion prevention can be implemented for example by two axial pins in the stationary housing part 12, which pins establish a form-fitting connection in opposing grooves on the seal ring carrier flange 46 (pins not shown in the drawings, for reasons of clarity). The stator seal ring 36 is fastened, e.g. pressed in or adhesively bonded, at the end face on the rotor-side end 34a of the seal ring carrier 34 or hollow piston 44, wherein other fastening techniques are also possible, however. In the present examples, the stator seal ring 36 is, by way of example, permanently fastened in a recess 52 of the seal ring carrier 34, more precisely of the flange 46.

In the present example, the closing of the mechanical seal 30 can be improved by an inner diaphragm 45 in the axial bore 47 of the hollow piston 44.

The stationary housing part 12 is preferably formed as a multipart feedthrough housing or multipart rotary union housing, such that, on account of the modular design, simple adaptability to existing housing shapes is possible. In the present examples, the stationary housing part 12 is formed in three parts and comprises a rotor housing 12a, in which the rotor 16 is mounted by means of the ball bearings 14, an intermediate housing part 12b, in which the stator seal ring assembly 32 is mounted in an axially displaceable manner and in which the tensioning device 100 is arranged, and a rear housing part 12c in which the media main channel 20 extends axially and into which the connection port 22 leads axially. Other housing designs are also possible, however.

The seal rings 36, 38 preferably both consist of silicon carbide (SiC), such that reference is often made to a SiC—SiC mechanical seal 30. A SiC—SiC mechanical seal 30 is durable and has excellent sealing properties during operation with liquid, highly lubricating media. However, some conventional rotary unions have stability problems in the case of operation with compressed air or in dry running with silicon carbide seals. SiC seal rings can for example overheat, if they run without lubricant and are not sufficiently separated from one another, which can lead even to complete failure of the rotary union. This can be prevented by embodiments of the present disclosure. However, other materials can also be considered for the seal rings 36, 38, such as carbon graphite (CG), i.e. for example a CG-SiC mechanical seal, or tungsten carbide (TC).

The seal ring assembly 32, in this example of the stator, or stator seal ring assembly 32 for short, or the hollow piston 44, is mounted in the stationary housing part 12 so as to be axially displaceable, by means of a secondary seal 60. In these examples, the secondary seal 60 comprises a secondary sealing ring 64 in the form of an elastomer annular seal. In the present examples, the elastomer annular seal 64 has a U-shaped cross section having a groove 66 which is open at the high-pressure side, and which is fluidically connected to the media main channel 20. Said annular seal 64 is therefore sometimes also referred to as a U-cup ring.

The mounting of the seal ring carrier 34 or the hollow piston 44 by means of the elastomer annular seal 64 allows the seal ring assembly 32 or the stator seal ring 36 a limited axial mobility, in order to be able to close the mechanical seal 30 and open it again. Typically, during operation with pressurized fluid media having liquid lubricant fractions, such as CL, cutting oil or hydraulic oil, the mechanical seal 30 is closed, such that at most a minimal optionally dropwise, leakage (known as bleeding) occurs. When the mechanical seal 30 is closed, such media ensure sufficient lubrication between the two silicon carbide sliding surfaces 36a, 38a. However, in dry running or in compressed-air operation, in the closed state, the two silicon carbide seal rings 36, 38 could rub against one another and heat up excessively. In order to prevent this, the mechanical seal 30 opens upon depressurization or in compressed-air operation, in that the seal ring carrier 34 or the hollow piston 44 together with the stator seal ring 36, i.e. the stator seal ring assembly 32, detaches from the rotor seal ring 38 and moves slightly axially away from this in the axial direction, i.e. to the right in the present figures.

The elastomer secondary seal 60 thus fulfils a dual function for the seal ring assembly 32, specifically as an axially displaceable mounting on the one hand, and as a seal against the pressurization with fluid medium from the stationary side, in the stationary housing part 12, on the other hand.

On account of the mounting by means of the elastomer sealing ring 64, the seal ring assembly 32 may also have a slight tilting capacity, such that the sealing surfaces 36a, 38a of the two seal rings 36, 38 of the mechanical seal, as the primary seal 30, rest completely flat against one another in the pressurized state, and can achieve a correspondingly good sealing effect. A stator seal ring 36 of this kind, which is axially displaceable in this way and is optionally slightly tiltable, is also referred to by experts as a floating seal ring.

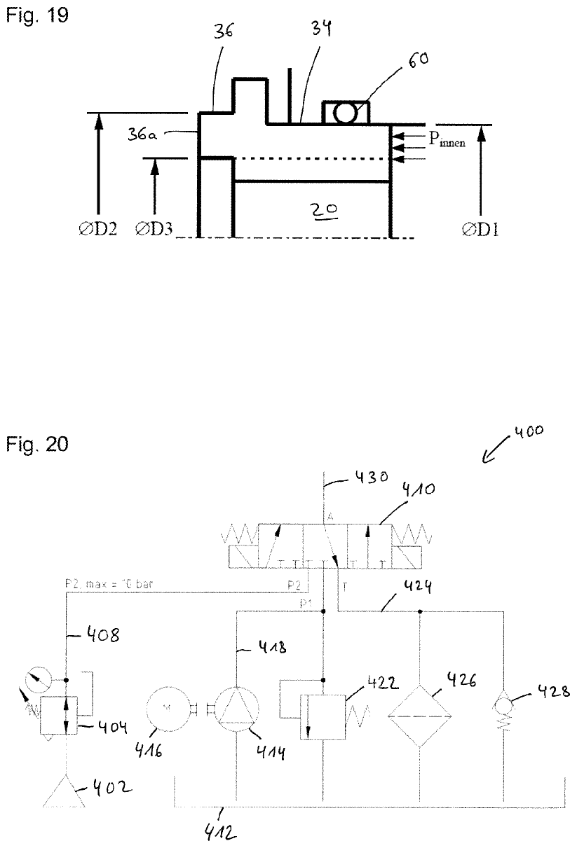

With reference to FIG. 19, the balance ratio B of a floating seal ring is defined by the area ratio F_{H}/F of the hydraulically or pneumatically loaded surface F_{H} to the contact surface F between the two seal rings 36, 38. Thus, the balance ratio B can be calculated geometrically, on the basis of the diameters D1, D2 and D3, as follows:

$$B = \frac{{F}_{H}}{F} = \frac{D {1}^{2} - D {3}^{2}}{D {2}^{2} - D {3}^{2}}$$

wherein D1 is the outside diameter or effective diameter of the pressurized seal ring carrier, D2 is the outside diameter of the contact surface of the mechanical seal, and D3 is the inside diameter of the contact surface of the mechanical seal.

If no medium pressure prevails, the stator seal ring assembly 32 is pulled back from the secondary seal 60 (to the right in the figures), as a result of which the seal ring assembly 30 is fully opened, such that the mechanical seal 30 can rotate, in dry without medium, in a manner having sufficient distance between the two seal rings 36, 38. Thus, in said completely open state (FIGS. 1, 4, 7, 10, 13 and 16) of the mechanical seal 30, there is a sufficiently large gap 39 between the seal rings 36, 38 for dry running without medium.

If compressed air is applied to the media main channel 20, this takes place at a low medium pressure, e.g. at an allowable maximum pressure of 10 bar, such that the pressure threshold value ps is not exceeded and the tensioning device or closing force amplification device 100 is not activated. As a result only the closing first axial force component K1 acts on the seal ring assembly 32, at the mechanical seal 30, which force component is generated by the balance ratio B, which in the present embodiment is approximately 0.5 to 0.57. Due to the relatively small balance ratio B, a small sealing gap 40 forms, which allows a controlled air leakage, which prevents wear at the sealing surfaces. If minimum quantity lubrication (RQL/MQL) is applied to the media main channel 20, this preferably also takes place at a medium pressure below the pressure threshold value ps. As a result, also only the first axial force component is effective, which is sufficient for RQL/MQL, in order to allow the RQL/MQL to flow into the fluid channel 17 of the rotor 16 in a substantially leak-free manner.

FIGS. 2, 5, 8, 11, 14 and 17 show the operating state of the mechanical seal in compressed-air operation, wherein the sealing gap 40 is so small, in compressed-air operation, that it cannot be shown in the figures.

The tensioning device 100 is installed in the stationary housing part 12, and specifically, in the present examples, to the rear of the flange 46 of the seal ring carrier 34. In the present example, the tensioning device 100 comprises two radially opposing pressure pistons 102, which are axially displaceably arranged in associated bores 104 in the stationary housing part 12. The pressure pistons 102 are in each case held in a non-activated state by one of the compression springs 106, counter to the medium pressure, in the present example towards the right, as long as the medium pressure does not exceed the predefined pressure threshold value. The pressure pistons 102 are thus accommodated in the stationary housing part 12 with open pressure springs 106.

The media main channel 20 is in fluidic communication with a rear pressure chamber 108 in such a way that, upon pressurization of the media main channel 20, the medium pressure acts, via the rear pressure chamber 108, on the respective rear end face 112 of the pressure piston 102 facing away from the rotor, and tensions the pressure pistons 102 counter to the springs 106 in the closing direction of the mechanical seal 30. The pressure pistons 102 are in each case sealed in the associated bore 104 by means of a seal 114, such that the medium pressure prevailing in the pressure chamber 108 exerts a pressure-proportional axial force component on the pressure pistons 102, counter to the spring tension of the spring 106. The spring tension of the spring 106 is now selected in such a way that the pressure pistons 102 are not activated, i.e. do not exert any force on the seal ring assembly 32, as long as the medium pressure is below the predefined pressure threshold value ps.

The area ratios of the pressure piston 102 and the spring force of the spring 106 are selected in such a way that, below the pressure threshold value ps, as shown in FIGS. 2, 5, 8, 11, 14 and 17, the pressure pistons 102 do not exert any force on the stator seal ring assembly 32, and the tensioning device 100 is thus in a non-activated state. In said non-activated state of the tensioning device 100, the closing force of the mechanical seal 30 is brought about on the mechanical seal 30, as a closing first axial force component K1, by the medium pressure, exclusively according to the balance ratio of the mechanical seal 30, i.e. based on the area ratio F_{H}/F.

With reference to FIGS. 3, 6, 9, 12, 15 and 18, the rotary union can be acted on via the same connection port 22 and the same media main channel 20 with a significantly greater medium pressure, e.g. up to 140 bar, 210 bar, or optionally higher, with a compressible liquid medium, for example cutting oil, hydraulic oil, or cooling lubricant. As soon as the medium pressure of the incompressible medium exceeds the pressure threshold value ps of, in this example, approximately 10 bar, the force acting on the pressure pistons 102, counter to the spring force of the springs 106, by the medium pressure, exceeds a threshold value of the spring force of the springs 106 to the effect that the pressure pistons 102 press against the flange 46 of the seal ring carrier 34, as a plunger, and act on said flange with a closing second axial force component K2 in addition to the first axial force component K1. As a result, the total closing force on the mechanical seal 30 is amplified beyond the closing force which is brought about by the balance ratio B.

Thus, if the medium pressure, in particular in the case of CL or cutting oil/hydraulic oil application, exceeds the predefined pressure threshold value ps, the tensioning device 100 is activated and exerts the additional closing second axial force component K2 on the mechanical seal 30. In the present examples, the pressure threshold value ps is selected so as to be equal to or slightly greater than the maximum allowable pressure for compressed air, i.e. ps≥10 bar.

The tensioning device 100 thus acts as the closing force amplification device, which is activated in response to the medium pressure in the media main channel 20 exceeding the pressure threshold value ps, and is not activated below the pressure threshold value ps. In the present embodiments, the actuation of the tensioning device 100 or closing force amplification device is brough about via the spring-loaded pressure pistons 102 that are subjected to a medium pressure above the pressure threshold value ps, e.g. 10 bar.

After switching off of the medium, the seal rings 36, 38 can be separated again by the Pop-Off® function.

In the embodiment shown in FIG. 1-6, rotor-side end face 116 of the pressure pistons 102 apply the second axial force component K2 directly to the seal ring carrier 34 or, more precisely, directly to the flange 46 of the seal ring carrier 34. In this case, the second axial force component K2, which is brought about by the tensioning device 100, as well as the first axial force component, which is brought about by the balance ratio B, are in each case proportional to the prevailing medium pressure.

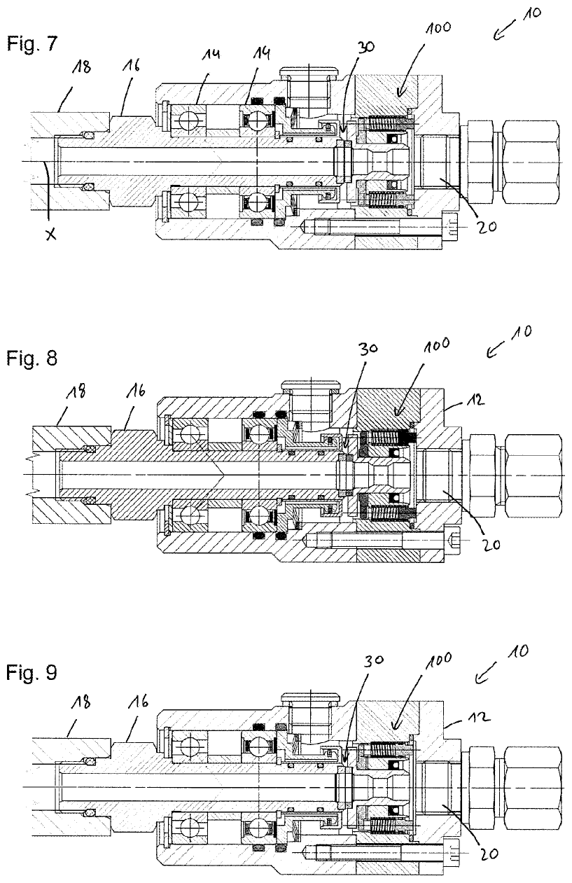

With reference to the embodiment shown in FIG. 7-12, the tensioning device 100 can further comprise a force-distributor ring 122 on which the pressure pistons 102 exert the second axial force component K2. In this case, the end faces 116 of the pressure pistons 102 come into contact with an outer annular region 124 of the force-distributor ring 122, upon the pressure threshold value ps being exceeded, in order to apply the second axial force component K2 to the force-distributor ring 122.

The force-distributor ring 122 comprises an annular force-distributing annular projection 126 which faces the mechanical seal 30 and which is in contact with the flange 46 when the tensioning device 100 is activated. The force-distributor ring 122 thus conveys the second axial force component, exerted by the pressure piston 102, to the seal ring carrier 34, or the flange 46 thereof. As a result, the second axial force component can be transmitted uniformly to the seal ring carrier 34 or to the floating seal ring 38, peripherally around the axis of rotation X, without generating undesired tilting moments. Furthermore, the force introduction onto the seal ring carrier 34 via the annular projection 126 can be displaced radially towards the inside, relative to the radial position of the pressure pistons 102. As a result, the deformation of the seal ring carrier 34 can be reduced or prevented.

In this case, the force-distributor ring 122 is mounted in the stationary housing part 12 so as to be axially movable, in particular so as to be axially movable relative to the seal ring carrier 34 and axially movable relative to the pressure pistons 102. The force-distributor ring 122 surrounds the seal ring carrier 34 for example in an annular and coaxial manner.

In the operating state for compressed-air operation (FIGS. 8 and 11), in particular no contact occurs between the force-distributor ring 122 and the seal ring assembly 32. In the operating state shown in FIGS. 9 and 12, upon pressurization with a compressible medium above the pressure threshold value ps the pressure pistons 102 press with a resulting force, brought about by the medium pressure on the pressure pistons 102 via the force-distributor ring 122 on the seal ring assembly 32. In this case, the second axial force component K2 generated thereby also behaves in a manner proportional to the medium pressure.

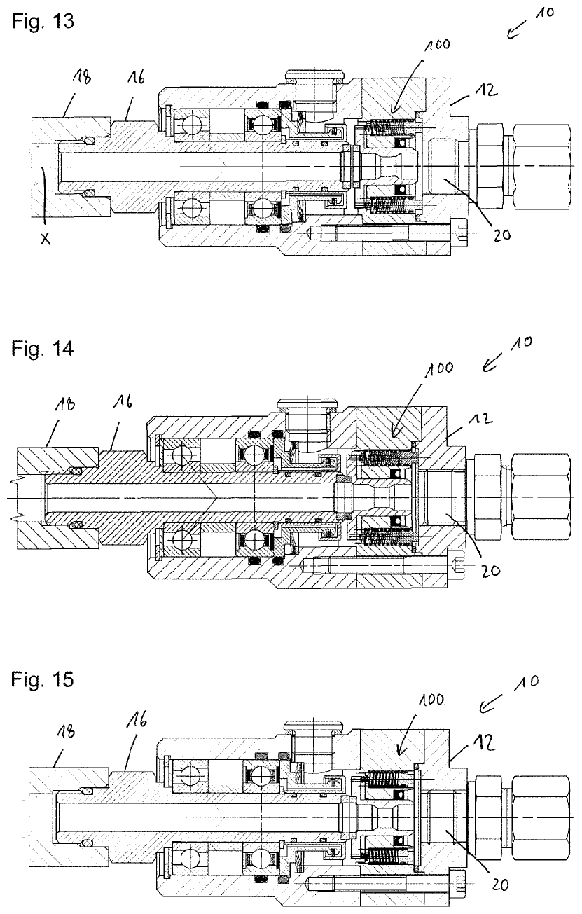

With reference to the embodiment shown in FIG. 13-18, the pressure pistons 102 can in each case comprise a closing force activation spring 132, which springs are arranged on the end face of the pressure pistons 102 facing the mechanical seal 30. For example, smaller closing force activation springs 132 are embedded in the end-face bores 134 of the pressure pistons 102.

As long as the medium pressure remains below the pressure threshold value ps, the tensioning device 100 is not active and the closing force activation springs 132 do not exert any force on the flange 46 of the seal ring carrier 34. When the medium pressure in the media main channel 20 and the pressure chamber 108 has exceeded the pressure threshold value ps to a sufficient extent, the pressure pistons 102 have moved axially in the direction of the mechanical seal 30, counter to the spring force of the springs 106, and the closing force activation spring exerts the second axial force component, via the seal ring carrier 34, in the present example via the flange 46, onto the floating seal ring 36. In this embodiment, the pressure pistons 102 strike a stop 136, when the pressure threshold value ps is sufficiently exceeded, and the second axial force component K2 is then exerted exclusively by the closing force activation springs 132, on the seal ring carrier 34. As a result, the second axial force component K2 does not increase further, even if the medium pressure in the media main channel 20 increases further. Thus, as soon as the pressure threshold value ps is exceeded to a sufficient extent, the second axial force component remains constant, independent of the pressure, brought about by the constant spring tension of the closing force activation springs 132. If the medium pressure in the media main channel 20 and the pressure chamber 108 acts on the pressure pistons 102 with a pressure that is significantly greater than the pressure threshold value ps, then the closing force activation springs 132 exert a constant pressure-independent second axial force component K2 on the seal ring assembly 32.

As in the embodiments in FIG. 1-12, the pressure pistons 102 are accommodated in the stationary housing part 12 by means of the open pressure springs 106. In contrast to the embodiments in FIG. 1-12, however, the stroke of the pressure pistons 102, in the embodiment shown in FIG. 13-18, is limited by the stop 136, and, even in the case of pressurization at pressures far above the pressure threshold value ps, can extend at most as far as the stop 136 within the stationary housing part 12. If the stop 136 is reached, the closing force activation springs 132 act simultaneously on the seal ring assembly 32 with a constant force. The spring force of the closing force activation springs 132 is for example 5 N per spring. As in the other embodiments, one or more pressure pistons 102, e.g. two to six, preferably two to four, pressure pistons 102 are possible in terms of space. For example, three or four pressure pistons 102, optionally comprising closing force activation springs 132, can be arranged annularly around the seal ring carrier 34.

In the non-activated state shown in FIGS. 14 and 17, below the pressure threshold value ps, for example in compressed-air operation, no contact occurs between the closing force activation springs 132 and the flange 46.

In summary, the rotary union 10 accordingly preferably has at least three operating states, as follows:
In the depressurized state, the rotary union 10 defines a fully open state of the mechanical seal 30 (dry-running operating state). In the fully open dry-running operating state, the two seal rings 36, 38 are separated from one another by a sufficiently large gap 39, such that the rotary union 10 can rotate without medium, during dry running, without wear resulting at the seal rings 36, 38.
In the case of pressurization with a medium pressure below the pressure threshold value ps, the rotary union defines an operating state for the operation with a compressible medium (compressed-air operating state). In said compressed-air operating state, the mechanical seal is open only minimally, in order to allow only a controlled (air) leakage. The sealing gap 40 that allows the controlled (air) leakage is so small that it is not visible in the corresponding FIGS. 2, 5, 8, 11, 14 and 17. In the compressed-gas operating state for compressible media, the tensioning device 100 is not activated. Only the first axial force component K1 acts on the mechanical seal 30.
In the case of pressurization with a medium pressure above the pressure threshold value ps, the rotary union defines an operating state for compressible media under a high medium pressure (liquid-medium operating state). In the liquid-medium operating state shown in FIGS. 3, 6, 9, 12, 15 and 18, the mechanical seal is closed and the tensioning device 100 is activated. Accordingly, in the liquid-medium operating state the first axial force component, based on the balance ratio B, and in addition the second axial force component, brought about by the activated tensioning device 100 act, added together as the total closing force, on the mechanical seal 30. As a result, a sufficient tightness can be achieved even for operation using higher-viscosity media such as cutting oil or hydraulic oil, in the case of a high medium pressure. During operation using cooling lubricant, the activation of the tensioning device 100 would probably not be essential on account of the lower viscosity, but is also not harmful.

Therefore, a purposeful closing force amplification can be brought about by the tensioning device 100 which is activated exclusively by the prevailing medium pressure. The closing force amplification is brought about in that the medium pressure inside the rotary union 10 exceeds the pressure threshold value ps, and the tensioning device 100 is activated in response to the pressure threshold value ps being exceeded, as a result of which the second axial force component K2 on the mechanical seal 30 is activated.

Thus, in the compressed-gas operating state, e.g. in compressed-air operation, a certain air leakage rate results at the mechanical seal 30, which, in the present embodiments, can be approximately 15-20 standard liters per minute, i.e. significantly lower than in the case of some conventional rotary unions. Furthermore, the present rotary union 10 has excellent dry running properties, since in dry running excessive heating of the seal rings 36, 38 can be prevented. The rotary union can therefore be operated in a largely unlimited manner with high rotational speeds, both without pressure during dry running, and in particular with compressed air in an allowable pressure interval of e.g. up to 10 bar.

If no pressure at all is present in the media main channel 20, the tensioning device 100 is not activated and the secondary seal 60 can pull back the floating seal ring 36 by means of what is known as the Pop-off® effect, such that there is no contact of the seal ring surfaces 36a, 38a, but rather a sufficiently large gap 39 results between said surfaces, and also an unlimited dry running can take place. If the mechanical seal 30 closes, specifically the U-cup ring 64 can deform slightly. Upon depressurization, the shape recovery assists the opening of the mechanical seal 30. However, embodiments of the present disclosure can also be equipped with another secondary seal 60.

In summary, the activation of the tensioning device or the closing force amplification device 100 is controlled or triggered in response to the magnitude of the prevailing medium pressure in the media main channel 20. In the case of low pressure, the tensioning device or the closing force amplification device is not activated, and in the case of higher pressure the tensioning device or the closing force amplification device is activated, i.e. is automatically activated in a hydraulically controlled manner. As a result, in particular one single media main channel is sufficient, into which channel all desired media can be introduced alternately in succession.

The activation and/or deactivation of the tensioning device or force amplifier device thus takes place purely mechanically/physically by the magnitude of the medium pressure of the medium introduced in each case, i.e. by increasing the pressure beyond the pressure threshold value ps or lowering the pressure below the pressure threshold value ps, in particular by depressurization.

Due to the amplification of the closing force when the tensioning device 100 is activated, in the case of a circuit with cooling lubricant or cutting oil or hydraulic oil (liquid-medium operating state), a high degree of tightness of the mechanical seal 30, and in the case of compressed-gas operation (compressed-gas operating state), e.g. with compressed air, a relatively low air leakage rate as well as good dry running properties (dry-running operating state), in particular with a Pop-Off® function, and high stability, can be brought into line with one another. Furthermore, in the case of operation with cooling lubricant, a high pressure, e.g. in particular greater than 90 bar, can be used, and the leakage rate nonetheless remains in an acceptable range, or the mechanical seal 30 is substantially leak-free. The embodiments can be operated e.g. with liquid media, CL or cutting oil optionally at e.g. up to 140 bar or even up to 210 bar or more, and with compressed air up to 10 bar, and with MQL up to 10 bar.

The air leakage or a slight remaining (gap) leakage of cooling lubricant or cutting oil or hydraulic oil can be discharged via a leakage port 91. A leakage connection coupling can be connected at the leakage port 91, in order to discharge leakage fluid or the controlled air leakage from a leakage chamber 94 outside the mechanical seal 30.

With reference to FIG. 20, the rotary union 10 according to the embodiments in FIG. 1-18 is supplied with the desired fluid media from an external media distribution network 400. For compressed-air operation, a compressed-air source 402 is connected, via a control valve 404 and a compressed-air supply line 408, to an external distributor 410. For operation using cutting oil, hydraulic oil or CL, a tank 412, as a media reservoir for cutting oil, hydraulic oil or CL as the liquid medium, is connected via a pump 414 to a motor 416 and an external liquid medium pressure supply line 418 is connected to the external distributor 410. The pump 414 generates the desired media pressure P1 for the cutting oil, hydraulic oil or CL, which can be e.g. up to 210 bar. In order to prevent excess pressure, the liquid pressure is limited by a pressure limiting valve 422 which leads back into the tank 412. Upon switching off of the liquid medium, the residual pressure of the liquid medium can be relieved back into the tank 412 again, via a return line 424 and a filter 426 having a parallel check valve 428, in order to set the media main channel 20 into a state without pressure.

In the present examples, the external distributor 410 is designed as a three-way valve (compressed air, liquid, return), and forms a media selection distributor for selecting the medium desired in each case. From the distributor 410, a pressure line leads, as a common connection line 430 for all media, to the common connection port 22, in order to introduce all the media, via the same connection port 22, into the same media main channel 20, alternately and in succession, in a pressurized manner.

In summary, a reliable, all media-compatible rotary union 10 can be provided, in which both compressible media, e.g. compressed air or RQL/MQL and also incompressible media, such as cooling lubricant (CL), cutting oil or hydraulic oil, can be introduced in succession into the same media main channel 20, in a pressurized manner. In this case, a high degree of reliability and variability for operation with all the different media is ensured.

It is clear for a person skilled in the art that the embodiments described above are to be understood as being by way of example, and the invention is not limited to these, but rather can be varied in a large number of ways, without departing from the scope of protection of the claims. Spatially orienting terms such as front or behind are not to be understood in absolute terms in space, but rather serve to designate the relative relationship of the components, wherein “front” refers to the rotor side, and “behind” or “rear” refers to the axial stator side opposite the rotor. Furthermore, it is clear that, irrespective of whether they are disclosed in the description, the claims, the drawings, or otherwise, the features also define components of the invention that are essential individually, and are to be considered to be individually disclosed hereby, even if they are described together with other features. In order to avoid unnecessary repetitions, all the features which are described in connection with one of the embodiments are also considered disclosed in connection with every other embodiment, unless something else is explicitly described.

1. A multimedia-compatible rotary union for transferring fluid media from a stationary machine part into a rotating machine part, in particular suitable both for compressible media and for incompressible media of different viscosities, comprising:
a stationary housing part for installation in the stationary machine part, and comprising a media main channel into which fluid media can be introduced in a pressurized manner,
a rotor for connection to the rotating machine part and having a rotor fluid channel, which is fluidically connected to the media main channel of the stationary housing part,
a mechanical seal between the stationary housing part and the rotor, wherein the mechanical seal comprises a rotor seal ring that rotates together with the rotor, and a stator seal ring, wherein the stator seal ring or the rotor seal ring is fastened to an axially movable seal ring carrier, by which an axially movable seal ring assembly is formed, wherein a pressure of a medium in the rotary union exerts a first axial force component on the axially movable seal ring assembly, which axial first force component has a closing effect on the mechanical seal, and
a tensioning device which acts on the axially movable seal ring assembly and which is activated by the medium pressure in the multimedia-compatible rotary union when the medium pressure in the multimedia-compatible rotary union exceeds a predefined pressure threshold value and which, in the activated state, exerts a second axial force component on the seal ring assembly, which second axial force component influences a closing force of the mechanical seal.

2. The multimedia-compatible rotary union according to claim 1, wherein the mechanical seal defines a balance ratio B=F_{H}/F, wherein
F_{H} is the surface area of the seal ring assembly that is loaded by the medium pressure, and F is the contact surface between the stator seal ring and the rotor seal ring, wherein the first axial force component on the seal ring assembly increases proportionally with the medium pressure in the multimedia-compatible rotary union, based on the balance ratio, and
wherein the tensioning device adds the second axial force component to the seal ring assembly, in addition to the first axial force component based on the balance ratio, when the medium pressure exceeds the predefined pressure threshold value and the tensioning device is activated.

3. The multimedia-compatible rotary union according to claim 1, wherein, when the medium pressure has exceeded the predefined pressure threshold value, the second axial force component of the tensioning device on the seal ring assembly is pressure-independent of or pressure-dependent on the medium pressure.

4. The multimedia-compatible rotary union according to claim 1, wherein the tensioning device comprises one or more springs, which are tensioned by the medium pressure in the stationary housing part.

5. The rotary union according to claim 4, wherein upon a predetermined spring tension threshold value being exceeded, the tensioning device is activated, and the second axial force component is exerted on the seal ring assembly.

6. The multimedia-compatible rotary union according to claim 1, wherein the seal ring carrier comprises an outer flange, on which the tensioning device engages, in order to transfer the second axial force component of the tensioning device to the seal ring assembly.

7. The multimedia-compatible rotary union according to claim 1, wherein the tensioning device comprises a force-distributor ring which distributes the second axial force component, exerted by the tensioning device, to the seal ring carrier in an annular manner.

8. The multimedia-compatible rotary union according to claim 1, wherein the tensioning device comprises one or more spring-loaded pistons which are tensioned against a spring force by the medium pressure and which exert the second axial force component of the tensioning device onto the seal ring assembly if and only if the medium pressure in the rotary union exceeds the pressure threshold value.

9. The multimedia-compatible rotary union according to claim 8, wherein the stationary housing part comprises one or more axial bores in which the one or more spring-loaded pistons are mounted so as to be axially displaceable.

10. The multimedia-compatible rotary union according to claim 9, wherein the one or more spring-loaded pistons are sealed in the respectively associated axial bore with a sealing ring.

11. The multimedia-compatible rotary union according to claim 9, wherein the medium pressure from the media main channel engages on rear end faces of the one or more spring-loaded pistons, in order to push the one or more spring loaded pistons, in a pressurized manner, in the respectively associated axial bore, counter to the spring force, in the direction of the mechanical seal.

12. The multimedia-compatible rotary union according to claim 8, wherein the tensioning device comprises at least two spring-loaded pistons, which are arranged in the stationary housing part uniformly around the seal ring carrier.

13. The rotary union according to claim 8, wherein the one or more spring-loaded pistons rest axially on one of the outer flange of the seal ring carrier or axially on the force-distributor ring, in order to transmit the second axial force component of the tensioning device directly onto one of the outer flange or the force-distributor ring, accordingly.

14. The multimedia-compatible rotary union according to claim 8, wherein
the stationary housing part comprises a stop for the one or more spring-loaded pistons which limits a stroke of the one or more spring-loaded pistons when the tensioning device is activated, and
wherein the one or more spring-loaded pistons each comprise a closing force activation spring which, in the activated state of the tensioning device, exert a constant medium pressure-independent spring force on the seal ring assembly, such that the second axial force component generated by the tensioning device is independent of the medium pressure when and as long as the tensioning device is activated.

15. The multimedia-compatible rotary union according to any of the preceding claims, wherein the pressure threshold value is greater than or equal to at least one of
a maximum admissible operating pressure of the multimedia-compatible rotary union for compressed-air operation, and
the pressure threshold value is greater than 5 bar, preferably greater than or equal to 10 bar.

16. The multimedia-compatible rotary union according to claim 1, wherein the multimedia-compatible rotary union comprises a connection port for connection of a media pressure line, in order to introduce all desired media into the media main channel, in each case having an associated medium-specific desired medium pressure, and wherein the multimedia-compatible rotary union is configured such that both compressible media and incompressible media can be introduced into the media main channel, in a pressurized manner, via the connection port.

17. The multimedia-compatible rotary union according to claim 16, wherein the connection port is one of an axial connection port or a radial connection port.

18. The multimedia-compatible rotary union according to claim 2, wherein the balance ratio of the mechanical seal has a value in the range from approximately 0.40 to 0.65, preferably in the range from approximately 0.45 to 0.60, preferably in the range from approximately 0.47 to 0.60, preferably in the range from approximately 0.50 to approximately 0.57.

19. The multimedia-compatible rotary union according to claim 1, wherein the seal ring carrier is sealed by a secondary seal in the stationary housing part and is axially displaceable, and wherein the secondary seal comprises an elastomer ring having a U-shaped cross section.

20. A method for operating a multimedia-compatible rotary union according to claim 1, comprising the steps of:
wherein an external compressed gas source is connected to a connection port of the multimedia-compatible rotary union via an external compressed gas supply line and an external distributor,
wherein an external media reservoir containing a liquid medium, is connected via a liquid medium pressure supply line, and the external distributor is connected to the connection port of the multimedia-compatible rotary union,
wherein, in a compressed-gas operating state, in a first time interval, a compressed gas is introduced via the compressed gas supply line and the connection port into the media main channel at a lower pressure than a pressure of the liquid medium, wherein the tensioning device is not activated and the multimedia-compatible rotary union rotates with compressed gas and with a closing force on the mechanical seal, which is defined by the first axial force component, and wherein later the compressed gas is switched off again,
wherein, in a liquid-medium operating state, in a second time interval, the liquid medium, at a higher pressure than a pressure of the compressed gas, is introduced via the liquid medium pressure supply line and the same connection port into the media main channel, wherein the tensioning device is activated by the liquid medium pressure, and the rotary union rotates with the liquid medium and with an added closing force on the mechanical seal, wherein the added closing force is made up of the first axial force component and the second axial force component, wherein the first axial force component is brought about by the balance ratio and the second axial force component is brought about by the tensioning device that is hydraulically activated by the medium pressure of the liquid medium, and wherein the liquid medium is later switched off again.

21. The method according to claim 20, wherein, in a dry-running operating state, in a third time interval, the multimedia-compatible rotary union rotates without the liquid medium, during dry running, wherein the tensioning device is not activated, and the mechanical seal is held open by the secondary seal.
